(19) United States
(12) Patent Application Publication
(10) Pub. No.: US 2005/0021558 A1
(43) Pub. Date: Jan. 27, 2005

(54) Network protocol off-load engine memory management

(76) Inventors: Harlan T. Beverly, McDade, TX (US); Ashish Choubal, Austin, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/460,290

(22) Filed: Jun. 11, 2003

(51) Int. Cl. G06F 17/00; G06F 7/00

(52) U.S. Cl. 707/104.1

(57) ABSTRACT

In general, in one aspect, the disclosure describes a method of processing packets. The method includes accessing a packet at a network protocol off-load engine, allocating one or more portions of memory from, at least, a first memory and a second memory, based, at least in part, on a memory map. The memory map commonly maps and identifies occupancy of portions the first and second memories. The method also includes storing at least a portion of the packet in the allocated one or more portions.

### BACKGROUND

Networks enable computers and other devices to communicate. For example, networks can carry data representing video, audio, e-mail, and so forth. Typically, data sent across a network is divided into smaller messages known as packets. By analogy, a packet is much like an envelope you drop in a mailbox. A packet typically includes “payload” and a “header”. The packet's “payload” is analogous to the letter inside the envelope. The packet's “header” is much like the information written on the envelope itself. The header can include information to help network devices handle the packet appropriately.

A number of network protocols cooperate to handle the complexity of network communication. For example, a protocol known as Transmission Control Protocol (TCP) provides “connection” services that enable remote applications to communicate. That is, much like picking up a telephone and assuming the phone company will make everything in-between work, TCP provides applications with simple primitives for establishing a connection (e.g., CONNECT and CLOSE) and transferring data (e.g., SEND and RECEIVE). Behind the scenes, TCP transparently handles a variety of communication issues such as data retransmission, adapting to network traffic congestion, and so forth.

To provide these services, TCP operates on packets known as segments. Generally, a TCP segment travels across a network within (“encapsulated” by) a larger packet such as an Internet Protocol (IP) datagram. The payload of a segment carries a portion of a stream of data sent across a network. A receiver can restore the original stream of data by collecting the received segments.

Potentially, segments may not arrive at their destination in their proper order, if at all. For example, different segments may travel very different paths across a network. Thus, TCP assigns a sequence number to each data byte transmitted. This enables a receiver to reassemble the bytes in the correct order. Additionally, since every byte is sequenced, each byte can be acknowledged to confirm successful transmission.

Many computer systems and other devices feature host processors (e.g., general purpose Central Processing Units (CPUs)) that handle a wide variety of computing tasks. Often these tasks include handling network traffic. The increases in network traffic and connection speeds have placed growing demands on host processor resources. To at least partially alleviate this burden, a network protocol off-load engine can off-load different network protocol operations from the host processors. For example, a Transmission Control Protocol (TCP) Off-Load Engine (TOE) can perform one or more TCP operations for sent/received TCP segments.

### BRIEF DESCRIPTION OF THE DRAWINGS

FIGS. 1A-1E illustrate operation of a network protocol off-load engine.

FIG. 2 is a diagram of a sample implementation of a network protocol off-load engine.

FIG. 3 is a diagram of a network interface card including a network protocol off-load engine.

### DETAILED DESCRIPTION

Network protocol off-load engines can perform a wide variety of protocol operations on packets. Typically, an off-load engine processes a packet by temporarily storing the packet in memory, performing protocol operations for the packet, and forwarding the results to a host processor. Memory used by the engine can include local on-chip memory, side-RAM memory dedicated for use by the engine, host memory, and so forth. These different memories used by the engine may vary in latency (the time between issuing a memory request and receiving a response), capacity, and other characteristics. Thus, the memory used to store a packet can significantly affect overall engine performance, especially when an engine attempts to maintain “wire-speed” of a high-speed connection.

Other factors can complicate memory management for an off-load engine. For example, an engine may store some packets longer than others. For instance, the engine may buffer segments that arrive out-of-order until the in-order data arrives. Additionally, packet sizes can vary greatly. For example, streaming video data may be delivered by a large number of small packets, while a large file transfer may be delivered by a small number of very large packets.

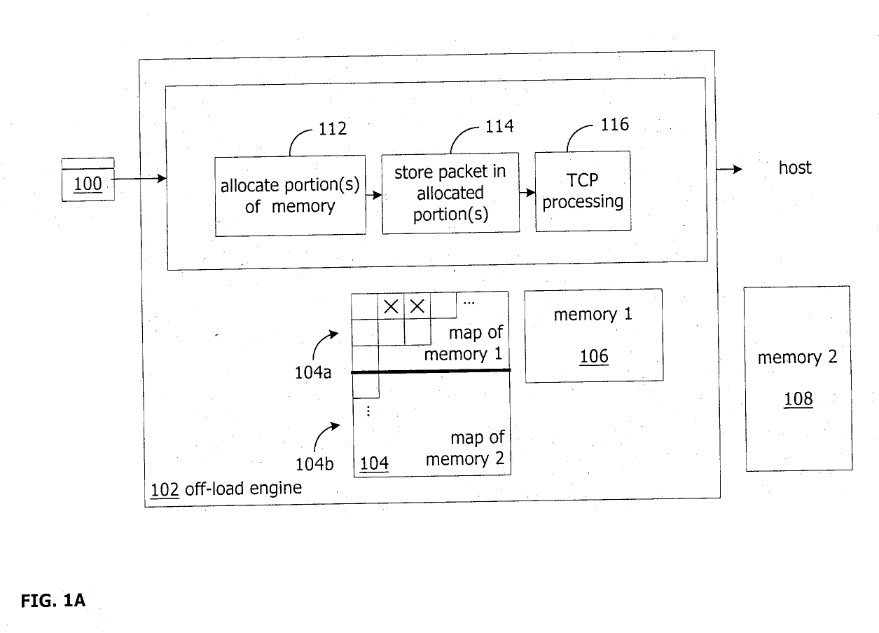

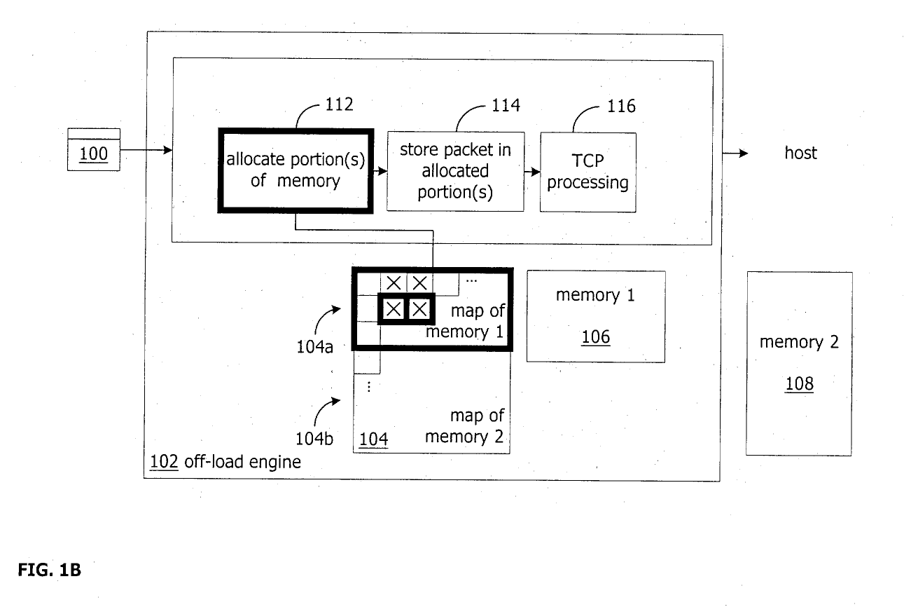

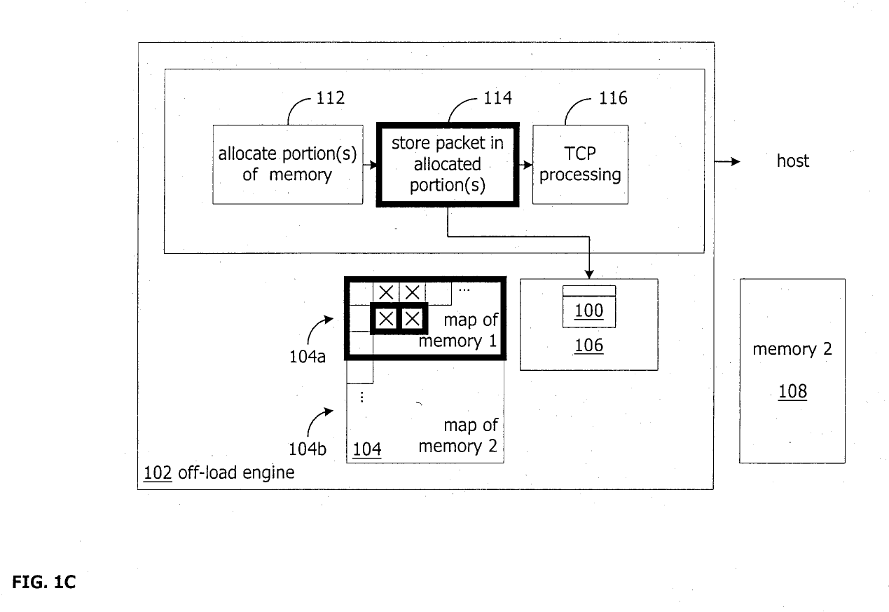

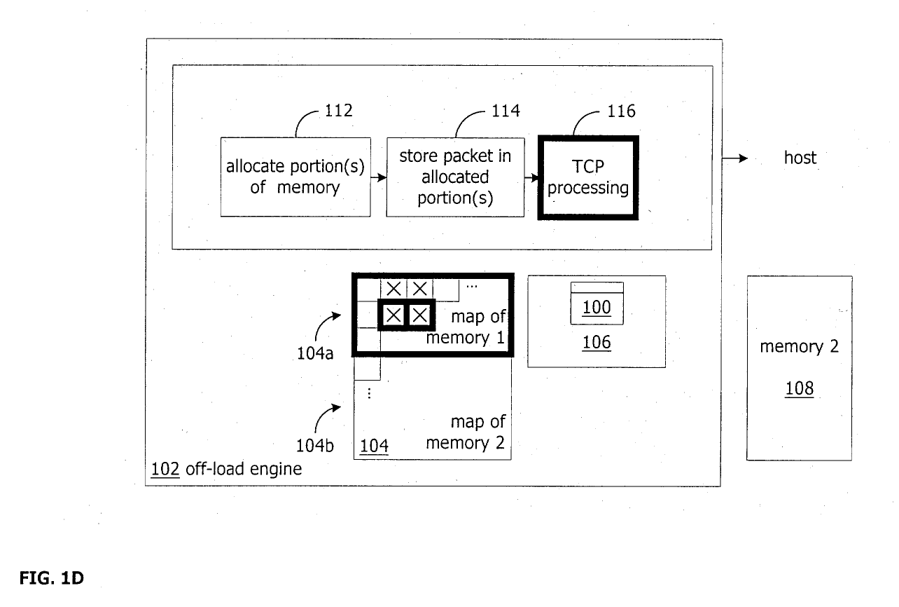

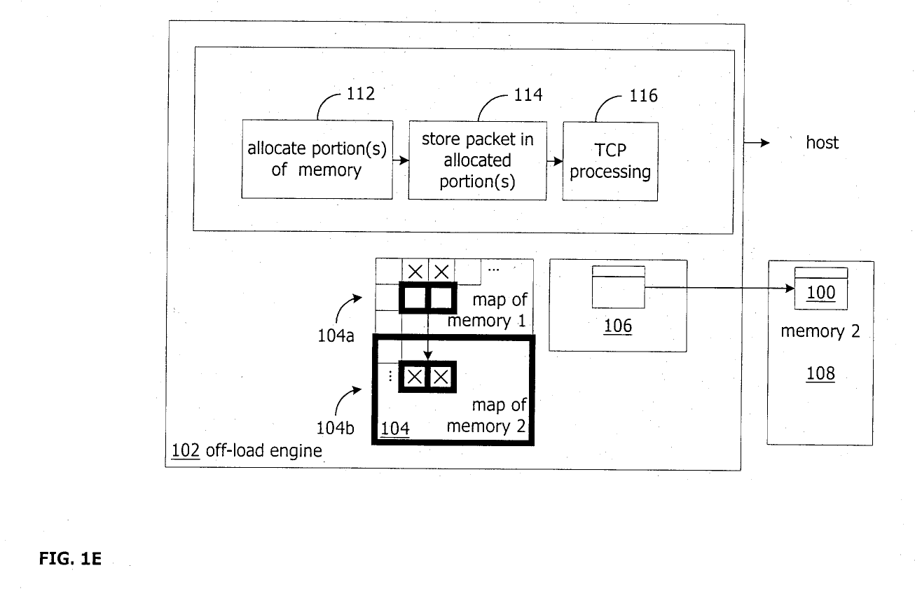

FIGS. 1A-1E illustrate operation of a sample off-load engine 102 implementation that flexibly handles memory management in a manner that can, potentially, speed packet processing and efficiently handle differently sized packets typically carried in network traffic. In the implementation shown in FIG. 1A, a network protocol off-load engine 102 (e.g., a TOE) can choose to store packet data in a variety of memory resources including memory on the same chip as the engine 106 (on-chip memory) and/or off-chip memory 108. To coordinate packet storage in memory 106, 108, the engine 102 maintains a memory map 104 that commonly maps portions of memory provided by the different memory resources 106, 108. In the implementation shown, the map 104 is divided into different sections corresponding to the different memories. For example, section 104a maps memory of on-chip memory 106 while section 104b maps memory of off-chip memory 108.

A map section 104a, 104b features a collection of cells (shown as boxes) where individual cells correspond to some amount of associated memory. For example, a map 104 may be implemented as a bit-map where an individual bit/cell within the map 104 identifies n-bytes of memory. For instance, for 256-byte blocks, cell #1 may correspond to memory at addresses 0x0000 to 0x00FF of on-chip memory 106 while cell #2 may correspond to memory at addresses 0x0100 to 0x01FF.

The value of a cell indicates whether the memory is currently occupied with active packet data. For example, a bit value of “1” may identify memory storing active packet data while a “0” identifies memory available for allocation. As an example, FIG. 1A depicts two “x”-ed cells within section 104a that identify occupied portions of on-chip 106 memory.

The different memories 106, 108 may or may not form a contiguous address space. In other words the memory address associated with the last cell in one section 104a may bear no relation to the memory address associated with the first cell in another 104b. Additionally, the different memories 106, 108 may be the same or different types of memory. For example, off-chip memory 108 may be SRAM while the on-chip memory 106 is a Content Addressable Memory (CAM) that associates an address “key” with stored data.

The map 104 can give the engine 102 a fine degree of control over where data of a received packet 100 is stored. For example, the map 104 can be used to ensure that data of a given packet is stored entirely within a single memory resource 106, 108, or even within contiguous memory locations of a given memory 106, 108.

As shown in FIG. 1A, the engine 102 processes a packet 100, by using the memory map 104 to allocate 112 memory for storage of packet data 100. After storing 114 packet data 100 in the allocated portion(s), the engine 102 can perform protocol operations on the packet 100 (e.g., TCP operations). FIGS. 1B-1E illustrate sample operation of the engine 104 in greater detail.

As shown in FIG. 1B, the engine 102 allocates 112 memory to store packet data 100. Such allocation can include a selection of the memory 106, 108 used to store the packet. This selection may be based on a variety of factors. For example, the selection may be done to ensure, if possible, that a given memory has sufficient available capacity to store the entire contents of the packet 100. For instance, an engine can access a “free-cell” counter (not shown) associated with each map 104 section to determine if the section has enough cells to accommodate the packet's size. If not, the engine may repeat this process with other memory, or, ultimately, distribute the packet across different memories.

Additionally, the selection may be done to ensure, if possible, that a memory is selected that can provide sufficient contiguous memory to store the packet. For instance, the engine 102 may search a memory map section 104a, 104b for a number of consecutive free cells representing enough memory to store the packet 100. Though such an approach may fragment the section 104a map into a scattering of free and occupied cells, the variety of packet sizes found in typical network traffic may naturally fill such holes as they form. Alternatively, the data packet could be spread across non-contiguous memory. Such an implementation might use a linked list approach to link the non-contiguous memories together to form the complete packet.

Memory allocation may be based on other factors. For example, the engine 102 may store, if possible, “fast-path” data (e.g., data segments of an on-going connection) in on-chip 106 memory while relegating “slow-path” data (e.g., connection setup segments) to off-chip 108 memory. Similarly, the selection may be based on other packet properties and/or content. For example, TCP segments having a sequence number identifying the bytes as out-of-order may be stored off-chip 108 while awaiting the in-order bytes.

In the example shown in FIG. 1B, the packet 100 is of a size needing two cells and is allocated cells corresponding to contiguous memory within on-chip 106 memory. As shown, consecutive cells within the map 104 section 104a for on-chip 106 memory are set to occupied (the bolded “x”-ed cells). As shown in FIG. 1C, the memory address(es) associated with the cell(s) is determined (e.g., address-of-first-section-cell+[cell-index*cell-size]), requested for use (e.g., malloc-ed), and used to store the packet data 100.

Since most packet processing operations can be performed based on information included in a packet's header, the engine 102 may split the packet in storage such that the packet and/or segment header is stored memory associated with one memory map 104 cell and the packet's payload is stored in memory associated with other cells. Potentially, the engine may split the packet across memories, for example, by storing the header in fast on-chip 106 memory and the payload in slower off-chip 108 memory. In such a solution a mechanism, such as a pointer from the header portion to the payload portion, links the two parts together. Alternately, the packet data may be stored without special treatment of the header.

As shown in FIG. 1D, after (or concurrent with) storing the packet in memory, the engine 102 can process the packet 100 in accordance with the network protocol(s) supported by the engine. Thereafter, the engine 102 can transfer packet data to memory accessible to a host processor, for example, via a Direct Memory Access (DMA) transfer to host memory (e.g., memory within a host processor's chipset).

Potentially, the engine 102 may attempt to conserve memory of a given resource. For example, while on-chip memory 106 may offer faster data access than off-chip memory 108, the on-chip memory 106 may offer much less capacity. Thus, as shown in FIG. 1E, the engine 102 may move packet data stored in the on-chip memory 106 to off-chip memory 108. For instance, the engine 102 may identify “stale” packet data stored in on-chip 106 memory such as TCP segment bytes received out-of-order or data not yet allocated host memory by a host sockets process (e.g., no posted “Socket Receive” or “Socket Receive Message” was received for that connection). In some cases, such movement effectively represents a deferred decision to store the data off-chip as compared to evaluating these factors during initial memory allocation 112 (FIG. 1B).

As shown, after making a determination to move at least a portion of the packet between memory resources 106, 108, the engine deallocates the on-chip 106 memory (e.g., marks the cells as free), allocates free cells within the map 104 section 104b associated with the off-chip 108 memory, stores the packet data in the corresponding off-chip 108 memory, and frees the previously used portion(s) of on-chip memory.

FIGS. 1A-1E illustrated operation of a sample implementation. A wide variety of other implementations may use techniques described above. For example, an engine may not try to allocate contiguous memory, but may instead create a linked list of packet data across discontiguous memory locations in one or more memory resources. While, potentially, taking longer to reassemble a packet, this technique can alleviate map fragmentation that may occur.

Additionally, instead of uniform granularity, the engine 102 may divide a map section into subsections offering pre-allocated buffer sizes. For example, some cells of section 104a may be grouped into three-cell sets, while others are grouped into four-cell sets. The engine may allocate or free the cells within these sets as a group. These pre-allocated groups can permit an engine 102 to restrict a search of the map 104 for available memory to subsections featuring sets of sufficient size to hold the packet data. For example, for a packet requiring four cells, the engine may first search a subsection of the memory map featuring pre-allocated sets of four-cells. Such pre-allocated groups can, potentially, speed allocation and reduce memory fragmentation.

In another alternative implementation, instead of dividing the memory map 104 in sections, individual cells may store an identifier designating which memory 106, 108 is associated with the cell. For example, a cell may feature an extra bit that identifies whether the data is in on-chip 106 or off-chip 108 memory. In such implementations, the engine can read the on-chip/off-chip bit to determine which memory to read when retrieving data associated with a cell. For example, some cell “N” may be associated with address 0xAAAA. This address, however, may be either in off-chip memory 108 or the key of an address stored in a CAM forming on-chip memory 106. Thus, to access the correct memory, the engine can read the on-chip/off-chip bit. While this may impose extra operations to perform data retrieval and to set the bit when allocating cells to a packet, moving data from one memory to another can be performed by flipping the on-chip/off-chip bit of the cell(s) associated with the packet's buffer and moving the data. This can avoid a search for free cells associated with the destination memory.

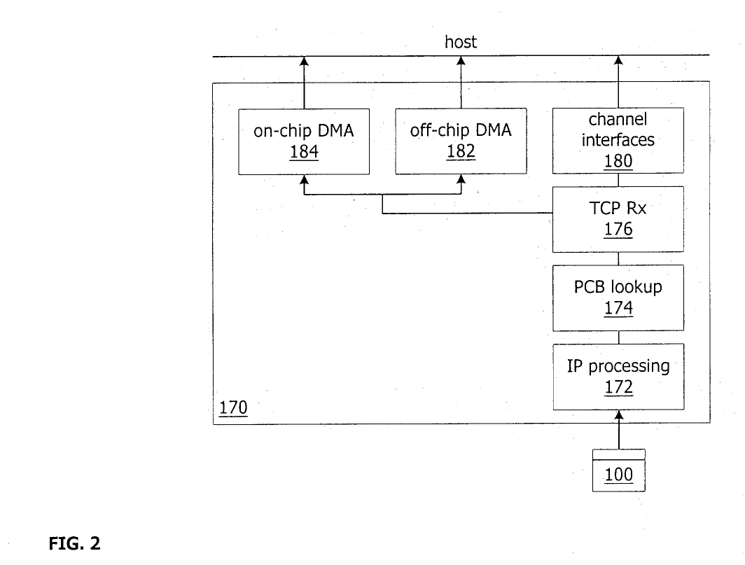

FIG. 2 illustrates a sample implementation of TCP off-load engine 170 logic. In the implementation shown, IP processing 172 logic performs a variety of operations on a received packet 100 such as verifying an IP checksum stored within a packet, performing packet filtering (e.g., dropping packets from particular sources), identifying the transport layer protocol (e.g., TCP or User Datagram Protocol (UDP)) of an encapsulated packet, and so forth. The logic 172 may perform initial memory allocation to on-chip and/or off-chip memory using a memory map as described above.

In the example shown, for packets 100 including TCP segments, Protocol Control Block (PCB) lookup 174 logic attempts to retrieve information about an on-going connection such as the next expected sequence number, connection window information, connect errors and flags, and connection state. The connection data may be retrieved based on a key derived from a packet's IP source and destination addresses, transport protocol, and source and destination ports.

Based on the PCB data retrieved for a segment, TCP receive 176 logic processes the received packet. Such processing may include segment reassembly, updating the state (e.g., CLOSED, LISTEN, SYN RCVD, SYN SENT, ESTABLISHED, and so forth) of a TCP state machine, option and flag processing, window management, ACK-nowledgement message generation, and other operations described in Request For Comments (RFCs) 793, 1122, and/or 1323.

Based on the segment received, the TCP receive 176 logic may choose to send packet data previously stored in on-chip memory to off-chip memory. For example, the TCP receive 176 logic may classify segments as “fast path” or “slow path” based on the segment's header data. For instance, segments having no payload or segments having a SYN or RST flag set may be handled with less urgency since such segments may be “administrative” (e.g., opening or closing a connection) rather than carrying data, or the data could be out of order. Again, if previously allocated on-chip storage, the engine can move the “slow path” data off-chip (see FIG. 1E).

After TCP processing, the results (e.g., a reassembled byte-stream) is transferred to the host. The implementation shown features DMA logic to transfer data from on-chip 184 and off-chip 182 memory to host memory. The logic may use a different method of DMA for data stored on-chip versus data stored off-chip. For example, the off-chip memory may be a portion of host memory. In such a scenario, off-chip to off-chip DMA could use a copy operation that moves data within host memory without moving the data back and forth between host memory and other memory (e.g., NIC memory).

The implementation also features logic 180 to handle communication with processes (e.g., host socket processes) interfacing with the off-load engine 170. The TCP receive 176 process continually checks to see if any data can be forwarded to the host even such data is only a subset of data included within a particular segment. This both frees memory sooner and prevents the engine 170 from introducing excessive delay in data delivery.

The engine logic may include other components. For example, the logic may include components for processing packets in accordance with Remote Direct Memory Access (RDMA) and/or UDP. Additionally, FIG. 2 depicted the receive path of the engine 170. The engine 170 may also include transmit path logic, for example, that performs TCP transmit operations (e.g., generating segments to carry a data stream, handling data retransmission and time-outs, and so forth).

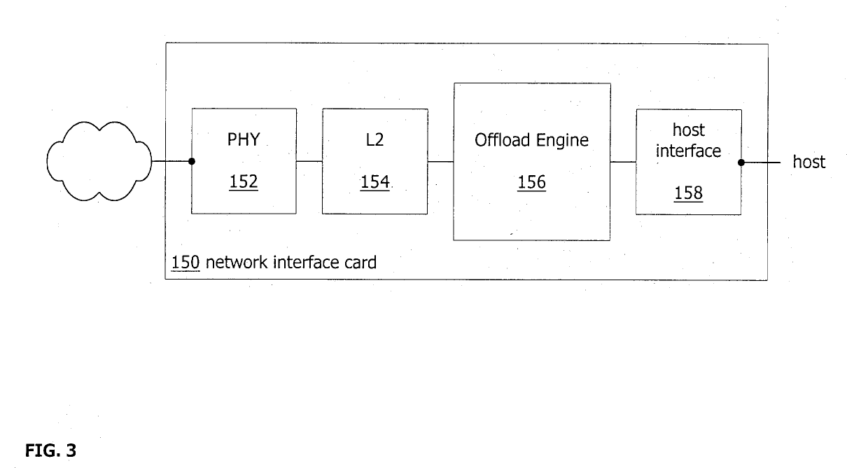

FIG. 3 illustrates an example of device 150 featuring an off-load engine 156. The device 150 show is an example of a network interface card (NIC). As shown, the NIC 150 features a physical layer (PHY) device 152 that terminates a physical network connection (e.g., a wire, wireless, or optic connection). A layer 2 device 154 (e.g., an Ethernet medium access controller (MAC) or Synchronous Optical Network (SONET) framer) processes bits received by the PHY 152, for example, by identifying packets within logical bit-groups known as frames. The off-load engine 156 performs protocol operations on packets received via the PHY 152 and layer 2 device 154. The results of these operations are communicated to a host via a host interface (e.g., a Peripheral Component Interconnect (PCI) interface to a host bus). Such communication can include DMA data transfers and/or interrupt signaling alerting the host processor(s) to the resulting data.

Though shown as a NIC, the off-load engine may be incorporated within a variety of devices. For example, a general purpose processor chipset may feature an off-load engine component. In addition, portions or all of the NIC may be included on a motherboard, or included inside another chip already on the motherboard (such as a general purpose Input/Output (I/O) chip).

The engine component may be implemented using a wide variety of hardware and/or software configurations. For example, the logic may be implemented as an Application Specific Integrated Circuit (ASIC), gate array, and/or other circuitry. The off-load engine may be featured on its own chip (e.g., with on-chip memory located within the engine's chip as shown in FIGS. 1A-1E), may be formed from multiple chips, or may be integrated with other circuitry.

The techniques may be implemented in computer programs. Such programs may be stored on computer readable media and include instructions for programming a processor (e.g., a controller or engine processor). For example, the logic may be implemented by a programmed network processor such as a network processor featuring multiple, multithreaded processors (e.g., Intel's® IXP 1200 and IXP 2400 series network processors). Such processors may feature Reduced Instruction Set Computing (RISC) instruction sets tailored for packet processing operations. For example, these instruction sets may lack instructions for floating-point arithmetic, or integer division and/or multiplication.

Again, a wide variety of implementations may use one or more of the techniques described above. For example, while the sample implementations were described as TCP off-load engines, the off-load engines may implement operations of one or more protocols at different layers within a network protocol stack (e.g., as Asynchronous Transfer Mode (ATM), ATM adaptation layer, RDMA, Real-Time Protocol (RTP), High-Level Data Link Control (HDLC), and so forth). Additionally, while generally described above as an IP datagram and/or TCP segment, the packet processed by the engine may be a layer 2 packet (known as a frame), an ATM packet (known as a cell), or a Packet-over-SONET (POS) packet.

Other embodiments are within the scope of the following claims.

1. A method of processing packets, the method comprising:
accessing a packet at a network protocol off-load engine;
allocating one or more portions of memory from, at least, a first memory and a second memory, based, at least in part, on a memory map, the memory map commonly mapping the first memory and the second memory, the memory map identifying occupancy of portions of the first and second memory; and
storing at least a portion of the packet in the allocated one or more portions.

2. The method of claim 1, wherein the memory map comprises a map divided into multiple sections, different sections mapping storage provided by different memories.

3. The method of claim 1, wherein a cell within the memory map comprises data identifying which of the first and second memories is associated with the cell.

4. The method of claim 1, wherein the network communication protocol off-load engine comprises a Transmission Control Protocol (TCP) off-load engine.

5. The method of claim 1, wherein the memory map is not a linear mapping of consecutive addresses in an address space.

6. The method of claim 1, wherein the first memory and the second memory comprise memories providing different latencies.

7. The method of claim 1,
wherein the first memory comprises a memory located on a first chip;
wherein the second memory comprises a memory located on a second chip; and
wherein the network communication protocol off-load engine comprises logic located on the first chip.

8. The method of claim 1, wherein the allocating comprises allocating based on content of the packet.

9. The method of claim 1,
wherein the first memory; and
further comprising:
making a determination to move at least a portion of the packet from the first memory to the second memory; and
causing the at least a portion of the packet to move from the first memory to the second memory.

10. The method of claim 1, wherein the memory map comprises a bit-map, individual bits within the bit map identifying the occupancy of a corresponding portion of memory.

11. The method of claim 1, wherein the allocating comprises allocating contiguous memory locations.

12. The method of claim 1, further comprising transferring the packet to a host accessible memory via Direct Memory Access (DMA).

13. The method of claim 1, wherein the network protocol off-load engine comprises one of the following: a component within a network interface card and a component within a host processor chipset.

14. The method of claim 1, wherein the network protocol off-load engine comprises at least one of the following: an Application Specific Integrated Circuit (ASIC), a gate array, and a network processor.

15. A computer program, disposed on a computer readable medium, the program including instructions for causing a network protocol off-load engine processor to:
access packet data received by the network protocol off-load engine;
allocate one or more portions of memory from, at least, a first memory and a second memory, based, at least in part, on a memory map, the memory map commonly mapping the first memory and the second memory, the memory map identifying occupancy of portions of the first and second memory; and
store at least a portion of the packet in the allocated one or more portions.

16. The program of claim 15, wherein the memory map comprises a map divided into multiple sections, different sections mapping storage provided by different memories.

17. The program of claim 15, wherein a cell within the memory map comprises data identifying which of the first and second memories is associated with the cell.

18. The program of claim 15, wherein the network communication protocol off-load engine comprises a Transmission Control Protocol (TCP) off-load engine.

19. The program of claim 15, wherein the memory map is not a linear mapping of consecutive addresses in an address space.

20. The program of claim 15, wherein the first memory and the second memory comprise memories providing different latencies.

21. The program of claim 15, wherein the instructions for causing the processor to allocate comprises instructions for causing the processor to allocate based on content of the packet.

22. The program of claim 15,
further comprising instructions for causing the processor to:
make a determination to move at least a portion of a packet from the first memory to the second memory; and
cause the at least a portion of the packet to move from the first memory to the second memory.

23. The program of claim 15, wherein the memory map comprises a bit-map, individual bits within the bit map identifying the occupancy of a corresponding portion of memory.

24. The program of claim 15, wherein the instructions for causing the processor to allocate comprise instructions for causing the processor to allocate contiguous memory locations.

25. A network interface card, the card comprising:
at least one physical layer (PHY) device;
at least one medium access controller (MAC) coupled to the at least one physical layer device;
at least one network protocol off-load engine, the engine comprising logic to:
access a packet;
allocate one or more portions of memory from, at least, a first memory and a second memory, based, at least in part, on a memory map, the memory map commonly mapping the first memory and the second memory, the memory map identifying occupancy of portions of the first and second memory; and
store at least a portion of the packet in the allocated one or more portions; and
at least one interface to a bus.

26. The card of claim 25, wherein the at least one interface comprises a Peripheral Component Interconnect (PCI) interface.

27. The card of claim 25, wherein the network protocol off-load engine logic comprises at least one of: an Application Specific Integrated Circuit (ASIC) and a network processor.

28. The card of claim 27, wherein the logic comprises a network processor, the network processor comprising a collection of Reduced Instruction Set Computing (RISC) processors.

29. The card of claim 25, network communication protocol off-load engine comprises a Transmission Control Protocol (TCP) off-load engine.

30. The card of claim 25, wherein the memory map is not a linear mapping of consecutive addresses in an address space.

31. The card of claim 25, wherein the first memory and the second memory comprise memories providing different latencies.

32. The card of claim 25,
wherein the first memory comprises a memory located on a first chip;
wherein the second memory comprises a memory located on a second chip; and
wherein the network communication protocol off-load engine comprises logic located on the first chip.

33. The card of claim 25, wherein the logic to allocate comprises logic to allocate based on content of the packet.

34. The card of claim 25,
wherein the network protocol off-load engine logic further comprises logic to:
make a determination to move at least a portion of the packet from the first memory to the second memory; and
cause the at least a portion of the packet to move from the first memory to the second memory.

35. The card of claim 25, wherein the memory map comprises a bit-map, individual bits within the bit map identifying the occupancy of a corresponding portion of memory.

36. The card of claim 25, wherein the memory map comprises a map divided into multiple sections, different sections mapping storage provided by different memories.

37. The card of claim 25, wherein a cell within the memory map comprises data identifying which of the first and second memories is associated with the cell.

38. A system comprising:
at least one host processor;
at least one physical layer (PHY) device;
at least one Ethernet medium access controller (MAC) coupled to the at least one physical layer device;
at least one Transmission Control Protocol (TCP) network protocol off-load engine, the engine comprising logic to:
access a packet received via the at least one PHY and the at least one MAC;
allocate one or more portions of memory from, at least, a first memory and a second memory, based, at least in part, on a memory map, the memory map commonly mapping the first memory and the second memory, the memory map identifying occupancy of portions of the first and second memory; and
store at least a portion of the packet in the allocated one or more portions.

39. The system of claim 38, wherein the PHY comprises a wireless PHY.

40. The system of claim 38, wherein the off-load engine comprises a component of at least one of the following: a network interface card and a host processor chipset.
